(19) United States
(12) Patent Application Publication
(10) Pub. No.: US 2016/0350776 A1
(43) Pub. Date: Dec. 1, 2016

(54) GEOLOCATION ANALYTICS

(71) Applicant: Wal-Mart Stores, Inc., Bentonville, AR (US)

(72) Inventors: Donald R. High, Noel, MO (US); Nicholas D. Rone, Bella Vista, AR (US); Brian Gerard McHale, Oldham (UK)

(21) Appl. No.: 15/164,207

(22) Filed: May 25, 2016

Related U.S. Application Data
(60) Provisional application No. 62/168,330, filed on May 29, 2015.

(51) Int. Cl. G06Q 30/02; H04W 12/06; G06Q 30/06

(52) U.S. Cl. CPC G06Q 30/0205; G06Q 30/0623; H04W 12/06; H04W 4/02

(57) ABSTRACT

Provided are a system and method for visualizing data analytics. An identifier is transmitted by a mobile electronic device of an interested party in or proximal a retail establishment to a computer in communication with a stored set of analytics regarding store items. Analytics of the set of analytics are determined within a geographic area proximal a current location of the mobile electronic device. Store items are located within the geographic area to which specific analytics of the determined analytics of the set of analytics correspond. Presented at the mobile electronic device are one or more analytics of the specific analytics in response to the identifier.

### RELATED APPLICATIONS

This application claims priority to U.S. Provisional Application Ser. No. 62/168,330, filed on May 29, 2015 entitled “Geolocation Analytics”, the entirety of which is incorporated by reference herein.

### FIELD

The present concepts relate generally to the field of computation and display of analytics in a retail environment, and more specifically, to systems and methods for geolocation based content delivery.

### BACKGROUND

Retail corporate executives, financial analysts, store managers, or other leaders often visit a store location to perform to collect performance metric data.

### BRIEF SUMMARY

In one aspect, provided is a method for visualizing data analytics, comprising transmitting an identifier by a mobile electronic device of an interested party in or proximal a retail establishment to a computer in communication with a stored set of analytics regarding store items; determining analytics of the set of analytics within a geographic area proximal a current location of the mobile electronic device; locating store items within the geographic area to which specific analytics of the determined analytics of the set of analytics correspond; and presenting at the mobile electronic device one or more analytics of the specific analytics in response to the identifier.

In some embodiments, the mobile electronic device of the interested party is authorized to receive the analytics in response to an acceptance of the transmitted identifier.

In some embodiments, the computer determines from the identifier at least one of an identification of the interested party, a role of the interested party, analytic authorization information, or a level of authorization.

In some embodiments, the mobile electronic device picks up an LED light transmission and communicates back to a location server the location of the user.

In some embodiments, the location server looks up the authority of the user, the available visualizations, statistical models associated with the visualizations, and data that is associated with the models, and wherein the location server applies a location factor to the model along with a default date range for the current data and a default date range for the data.

In some embodiments, the method further comprises determining a location of the mobile electronic device in the retail establishment; and providing the analytics as analytical visualization data to the mobile electronic device according to the location of the mobile electronic device.

In some embodiments, when the mobile electronic device is at a first distance from an item of interest to which the analytics correspond, a first amount of analytical visualization data is displayed at the mobile electronic device, and wherein when the mobile electronic device is at a second distance from the item of interest that is greater than the first distance, then a second amount of analytical visualization data is displayed at the mobile electronic device that is less than the first amount of analytical visualization data.

In some embodiments, the method further comprises receiving, by the mobile electronic device, an LED light transmission of a value that is mapped to a geographical location on a digital store map; identifying, by the computer, from the value the geographical location where the interested party having the mobile electronic device is located; and searching for the available analytics and using the location of the retail establishment as a factor in the query to limit the data retrieved to just analytics for the store.

In some embodiments, the number emitted by the LED light transmission identifies a store department.

In some embodiments, the computer provides default analytics and visualization to the mobile electronic device, which can be updated to include different analytics based on a security level of the interested party.

In some embodiments, the method further comprises scanning a store item by the mobile electronic device; and querying by the computer analytics related to the scanned store item.

In some embodiments, the analytics are generated according to hierarchical levels.

In some embodiments, the hierarchical levels include store, department, modular, and item levels.

In some embodiments, the method of claim 1 further comprises generating a default analytic and visualization based on the user's authority and access permissions.

In another aspect, provided is a method for providing geolocation-sensitive analytics, comprising authorizing a mobile electronic device of user to receive analytic data corresponding to at least one item of interest; receiving, by an analytics system, an identifier from the mobile electronic device; and providing the analytics as analytical visualization data to the mobile electronic device based on the identifier and a result of authorizing the mobile electronic device.

In some embodiments, the analytics are generated according to hierarchical levels.

In some embodiments, the hierarchical levels include store, department, modular, and item levels.

In some embodiments, the amount of analytical visualization data displayed at the mobile electronic device is dependent on the location of the mobile electronic device from the at least one item of interest.

In some embodiments, the method further comprises generating a default analytic and visualization based on the user's authority and access permissions.

In another aspect, provided is an analytics system, comprising a geo-location processor that determines a mobile device location relative to items, store areas, departments, vendors, fine-line, and/or categories of interest and have corresponding analytic data; an analytics processor that retrieves available analytics of the analytic data based on the mobile device location; and a visualization generator that outputs visualizations related to selected analytics of available analytics.

In some embodiments, the analytics system further comprises an item analyzer that analyzes one or more store items proximal to the mobile device location by evaluating sales, profits, or other affinities regarding an item for determining analytic-related information.

In some embodiments, the analytics system further comprises a threshold generator that compares an item performance level to a threshold value, and generates an alert of analytics regarding the item when the item performance level is greater than the threshold level.

In some embodiments, the analytics system further comprises an authentication processor that processes authentication data received from the mobile device to determine whether the user is authorized to receive analytic data and visualizations, and at what level of authority and access.

### BRIEF DESCRIPTION OF THE SEVERAL VIEWS OF THE DRAWINGS

The above and further advantages of this invention may be better understood by referring to the following description in conjunction with the accompanying drawings, in which like numerals indicate like structural elements and features in various figures. The drawings are not necessarily to scale, emphasis instead being placed upon illustrating the principles of the invention.

FIG. 1 is a block diagram of an environment in which embodiments can be practiced.

FIG. 2 is a process flow diagram illustrating a method for providing geolocation-sensitive analytics, in accordance with some embodiments.

FIG. 3 is a view of an array of visualizations, which may be presented in accordance with some embodiments.

FIG. 4 is a process flow diagram illustrating a method for providing geolocation-sensitive analytics, in accordance with some embodiments.

FIGS. 5 - 8 are illustrations of various visualizations, in accordance with some embodiments.

### DETAILED DESCRIPTION

In the following description, specific details are set forth although it should be appreciated by one of ordinary skill in the art that the systems and methods can be practiced without at least some of the details. In some instances, known features or processes are not described in detail so as to not obscure the present invention.

Retailers collect performance data at brick and mortar stores. Well-known analytic or data mining techniques may be applied to the collected raw data for analysis, for example, to identify patterns in the data, analyze shopping patterns, explain sudden or ongoing fluctuations in sales or profits, produce customer profiles, and so on. However, this data is not always available when an on-site representative visits the store location and wishes to review analytics-related information in real-time or near real-time. When information is missing or expired, the on-site representative is often underinformed or misinformed, and may result in poor decisions made due to the lack of relevant information.

In accordance with preferred embodiments, on-site store visitors such as retail corporate executives, financial analysts, store managers, or other leaders may receive alerts indicating that they can receive and view analytics at their mobile electronic devices automatically, and in real-time or near real-time. In particular, when the visitor, e.g., a store executive, enters a predetermined area at a retail location, the visitor's mobile electronic device, for example, a smart device, communicates with an analytics system to determine if there are available analytics corresponding to products of interest in the same area as the visitor. To achieve this, the current location is communicated using geolocation technology to the mobile device, for example, through a photo cell in the mobile device. The mobile device can be used to scan an item to retrieve available analytics related to the item. If so, the visitor's device may display information that permits the visitor to identify the products of interest in the same area as the mobile device that have available analytics. The user can select the items he/she wishes to find whereby the system can provide to the mobile electronic device a list of available analytical information for viewing. The retrieved analytics can be used for management analysis or other purposes.

Accordingly, mobile device users can view relevant information based upon their location. The further away the user is from items of interest, the higher the summary of information. The closer the user is to the items of interest, the more detailed the information. For example, a user not located at a department having items of interest can view information at the store level. If the user is located in the department but not at a particular modular or display holding the items of interest, then the user's mobile device can display summary information at the department level for that store. If the user is located at or near the modular, then relevant summary information is displayed at the modular level. In the hierarchy, the user may scan an item at the mobile device, barcode scanner, or other scanning device, resulting in the display of information at the item level. The user may change between hierarchy levels, for example, between store, department, modular, and item levels. Alternatively, users can view location level information, for example, any analytics available corresponding to items that are a predetermined distance from the current location of the user. Accordingly, what is automatically delivered to the user's mobile device can be based upon the user's location. Manual entries can be made to modify currently displayed data, or override the data automatically presented based on the user's location, or a particular hierarchy level.

The user can be provided with a “starting point” with a set of default analytics, which can be modified, or manually overridden by changing the factors, criteria, items of interest, or other display data. For example, a store manager may receive default data related to recent sales at a particular department, e.g., a sporting goods department, at the manager's “home store.” However, the manager may be responsible for several stores, and may therefore change these factors to a different store, or to the store at which the manager is currently physically located, and to different department sales data, for example, men's apparel. The reason for this change may vary, for example, due to an anomaly created by a weather-related occurrence.

Another feature is that a device in accordance with some embodiments is configurable as not to “spam” the user with available analytics for which the user has no interest. Here, a user can enter preferences into the system. For example, the user may be interested in viewing data regarding toy sales at one department. The other departments are not available to provide data, and the user would only be notified when the user approaches the toy department. In another example, the user may enter a preference regarding a particular store, or town or region at which one or more stores are located. Here, the user would be notified of analytics when they are at the particular store. The user sets the preferences as to what hierarchy level (store, department, and so on) the user wishes to see and what values they wish to see. Otherwise, the user is notified each time the user moves from one area to other. The user can receive notifications via instant message (IM), text message, Email, voicemail, and so on, and/or a hypertext link or the like to the relevant data, for example, the analytics.

The device can also be user-configurable in that a user of a computer with a display can establish from the display user interface a rate, quantity, and/or criteria of the analytic data of interest. For example, a leader at a store can indicate which products, vendors, store departments, and so on the user is interested in, so that relevant analytics are provided to the device display based on the interest.

Another feature is that data scientists can create analytic statistical models which can be applied to any product. For example, data scientists can create visualizations with location variables so that particular analytics are associated with an item, store department, or hierarchical element that may be of interest to the user and that is proximal to the user's mobile device to trigger the display of the analytical visualizations. In particular, analytics are established according to hierarchical levels. This permits data to be provided in aggregate, for detail or summary levels based upon hierarchy level selected. A related feature is that the system maintains available analytics and incorporates a threshold of when to activate for an item, fine-line, vendor, or department within inventory.

For example, a fine-line level in the hierarchy may include a particular brand of a beverage. However, within the brand may include different configurations, such as 12 pack cans in a box in the lowest item level, as opposed to a 6 pack of plastic one liter bottles. The fine line here may be regular (sugared) beverage. The user may wish to view performance data regarding the sugared beverage, or specific information relevant to 12 pack cans in a box.

A threshold may be established for special alerts when a product exceeds a performance level. It may be set by the user for a positive or negative performance level. When the threshold is reached, the display of the analytics will be flagged by a highlighted color, note, bold type, or flashing to gain the user's attention.

A visualization may include any visual depiction or graphical arrangement of data and/or calculations based on analytic data. Analytics can relate to the numbers returned based upon the location criteria supplied, or an item number supplied from a barcode can and a location (e.g., store, city, state, country). The analytics configured as visualizations such as graphs, charts, and so on permit the viewer to understand and see anomalies. The system presents to a display visualizations that are particularly important in analytic software, where effective analysis of data can affect profitability, goal attainment, and so on, or to enhance awareness and improve decision making.

The analytics system 1 accordance with some embodiments can present visualizations by employing various menu items, buttons, and other Graphical User Interface (GUI) controls to facilitate selecting underlying data, performing calculations or operations on underlying data, and for manipulating visualizations. Example visualization manipulations include pivoting, zooming, filtering of data, drilling into data (i.e., illustrating more detail), adding or removing dimensions and measures from a visualization, and so on. Alternatively, certain mechanisms for manipulating visualizations are embedded in the visualization itself. However, such mechanisms remain relatively inefficient and incomplete, and they may still require users to navigate complicated menus to select desired options. Such inefficiencies may further inhibit the adoption of analytic software among enterprises.

Another feature is that the system uses location information to build a hierarchy (e.g., store, city, county, state, division, country, and so on). For example, a store can be determined according to GPS, in particular, the store's street address, city, country, state, and country. From that GPS coordinates are derived by this information on the lookup table in a database. The user's mobile device can provide the GPS data which is transmitted to the system for conversion into the address, city, state, country.

As described above, when items are placed within a store, they are associated with the store as inventory for purchase, which is captured at by a point of sale (POS) system or the like. When the store is set up in the database by the home office associates, the hierarchy of store, city, state, division, country is also associated with the store.

This permits a data scientist to aggregate summary totals at any level for an item, so that a user can view data indicating how the item is performing in one or more levels of the hierarchy, for example, U.S. sales, state sales, town sales, store-specific sales, and so on. The hierarchy permits a user to move up or drill down a hierarchical level and perform comparisons with other like geographies, for example, store performance in one town compared to store performance in another town.

Users such as leaders can receive transmissions through their mobile devices which verifies that they are in an area identified from the location information. The system can use their position to search for available analytics for products or items within the identified area where the user is located. Once analytics are identified for particular items, the system can return that information to the leader's mobile device display so that the leader can select which analytics the leader is interested in for viewing at the display. The system can include a memory for recording actions taken by the user at the mobile device, such as moving to different locations, selecting certain analytics, and so on, which can be used for future analysis and/or performance reporting. This data can be used by others for analyzing the effectiveness of the analytics program and the leaders’ acceptance and use of the program.

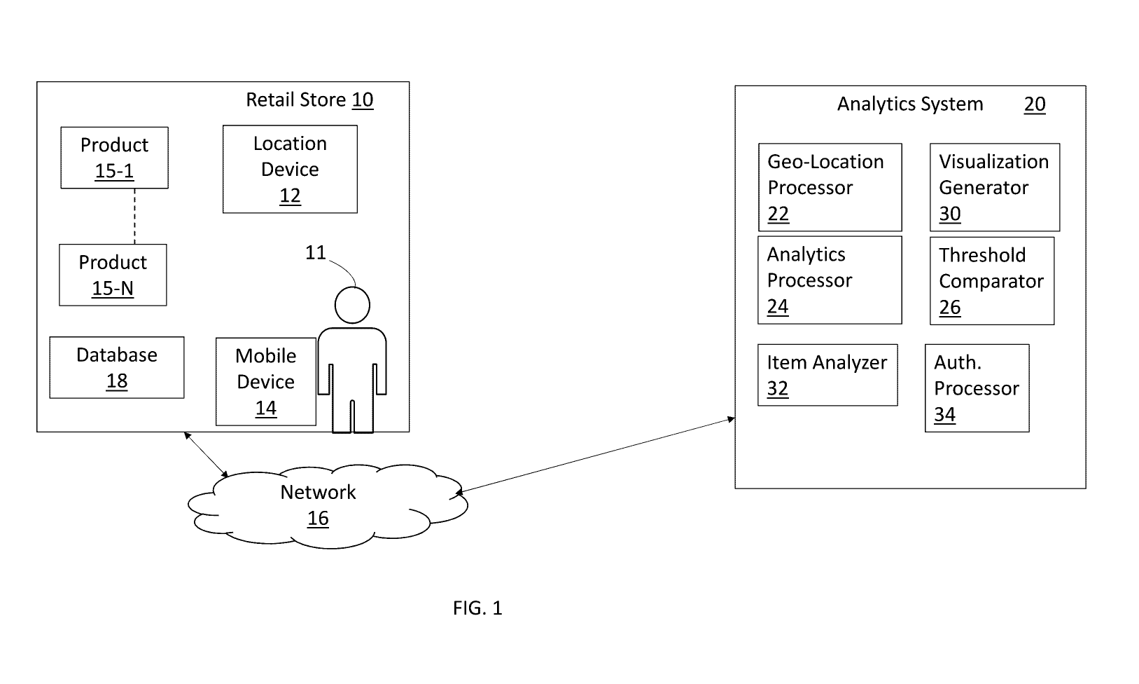

FIG. 1 is a block diagram of an environment in which embodiments can be practiced. The environment includes at least one retail store 10 and an analytics system 20.

The retail store 10 is a brick-and-mortar store having a physical location at which a plurality of different items or products 15-1 through 15-N (generally, 15) are available for purchase by customers. Attached to the products 15 may include a barcode, QR code, radio frequency identification (RFID) tag with product identification information, or the like so that an electronic device 14 such as a mobile device can receive location information. Location information may be received from GPS information, which may match data for the store address, city, state, and country. This information may be received via a photo cell in the device 14, which can be used to distinguish the products 15 from each other and/or provide information regarding the products 15 to the analytics server 12, a barcode scanner (not shown), and/or other electronic device. For example, the mobile electronic device 14 can read a barcode through image processing, or scan an item label and perform image recognition, and provide the scan result to the analytics system 20 for processing. In another example, an RFID reader interfaces with the mobile electronic device 14, or the mobile electronic device 14 includes an RFID reader.

A user 11 may be in possession of a mobile electronic device 14. The user may be a leader, store manager, or other person of authority interested in obtaining information about products, departments, or other store-related activity, for example, for business or finance-related reasons. At the retail store 10 may include one or more location devices 12 that provide location transmissions and other network communications with respect to the user's mobile electronic device 14, for example, to alert the user of available analytics corresponding to items of possible interest at or near the location of the user's mobile electronic device 14.

The location device 12 is configured to determine the location of the in-store device 14 within the retail store 10. The location device 12 may use a suitable indoor positioning system to establish the position of the in-store device. The determined location may comprise coordinates representing a position of the device 14 on a map of the retail store 10. In one example, the indoor positioning system may be based on modulated visible light. Particularly, a plurality of LED lights configured to emit modulated visible light may be installed within the retail store 10. In one example, the LED lights are light fixtures produced by ByteLight™. In some embodiments, the location device 12 includes an LED lights or other indoor location that use light to devices, which may utilize technologies such as Visible Light Communication (VLC), Bluetooth Low Energy (BLE), or the like. In further examples, the indoor positioning system may employ the Global Positioning System (GPS), Wi-Fi, Near-Field Communication (NFC) or any other suitable positioning technology. It will be understood that the location device 12 may employ a plurality of positioning technologies, e.g. depending on the level of granularity required, or to provide a fall back in case of technical problems. The mobile electronic device 14 may pick up an LED light transmission and communicate back to a location server the location of the user 11.

A database 18 may be provided that is located at the store 10, or at a remote location such as a data center, or computing cloud, or the like which stores data related to product inventory, pricing, discount information, product identifiers, and so on, which can be used to retrieve or generate geolocation analytics, or available analytics for products or items within a particular area.

The location device 12, database 18, analytics system 20, and mobile electronic device 14 communicate with each other by a communication network 16. The communication network 16 may take any suitable form, including secure wired and/or wireless communication links, as will be familiar to those skilled in the art. In further examples, the location device 12, database 18, and/or analytics system 20 may be located off-site, for example in a central or regional data processing site, rather than in the store 10.

The analytics system 20 includes a geolocation processor 22, an analytics processor 24, a threshold comparator 26, a visualization generator 30, an item analyzer 32, and an authentication processor 34. Some or all Some or all of these elements of the system 20 are co-located on a common hardware platform, for example, are stored in a memory, such as a random access memory (RAM), a read-only memory (ROM), or other storage device, and executed by one or more hardware processors (not shown). The hardware processors can be part of one or more special-purpose computers, such that execute computer program instructions which implement one or more functions and operations of the system 20.

The geolocation processor 22 processes location information, for example, received from the location device 12 at the retail store 10 and/or other geolocation technology, and/or directly from the user's mobile electronic device 14 at the store, for example, to determine the user's location relative to items, store areas, departments, vendors, fine-line, and/or categories that may be of interest and have corresponding analytic data. A location server may look up the authority of the user, the available visualizations, statistical models associated with the visualizations, and data that is associated with the models, and apply a location factor to the model along with a default date range for the current data and a default date range for the data., described herein.

For example, geolocation technology can include a plurality of LED smart lights that are mapped as to what area the light projects, for example, the emitted light corresponding to a number, which in turn identifies a location on the store floor. The collection of lights/numbers can be translated to grid position within the store on a 2D and 3D digital map. The mobile electronic device 14 can receive and process the location number from the LED light. The mobile electronic device 14 can output the number to the analytics system 20, which looks up the number in a database of associated LED light numbers identifying a specific grid area of the store 10. The grid area identified by the number may be associated with analytics based upon the items within the grid area. The analytics for that grid section are communicated back to the mobile electronic device 14 for the user 11 to make a selection of the information the user wishes to view. Alternatively, the user 11 may view the data at a grid area summary level.

The analytics processor 24 searches for store analytics based on one or more of a user location, store location, user authentication data, item information to determine data., for example, analytics, visualizations, or the like to provide to the mobile electronic device 14.

The analytics processor 24 may communicate with the item analyzer 32 to provide data generated from the item analyzer 32 as visualizations to the mobile electronic device 14. The item analyzer 32 can place the lowest level of granularity of data in a hierarchy for aggregations at many different levels, permitting the user 11 to view the data at any level the user wishes based upon the hierarchical scheme.

The threshold comparator 2.6 allows the user 11 to indicate a threshold level for product performance that would alert the user 11 when the threshold is exceeded. For example, the user 11 can walk through the store 10 without being alerted of any analytics unless a threshold is exceeded. This narrows down “spam” notifications to only when thresholds for an item are exceeded. For example, if a product exceeds a high performance level, then the mobile electronic device 14 may receive a notification. Similarly, if a product exceeds a low performance level, then the mobile electronic device 14 may receive a notification.

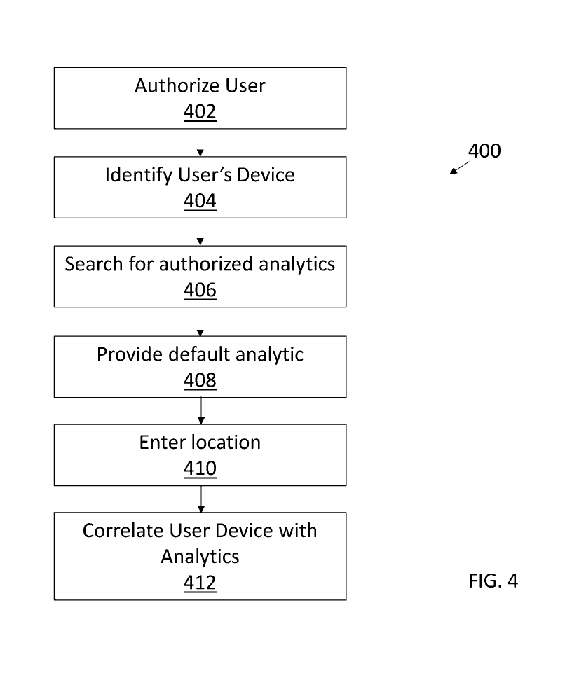

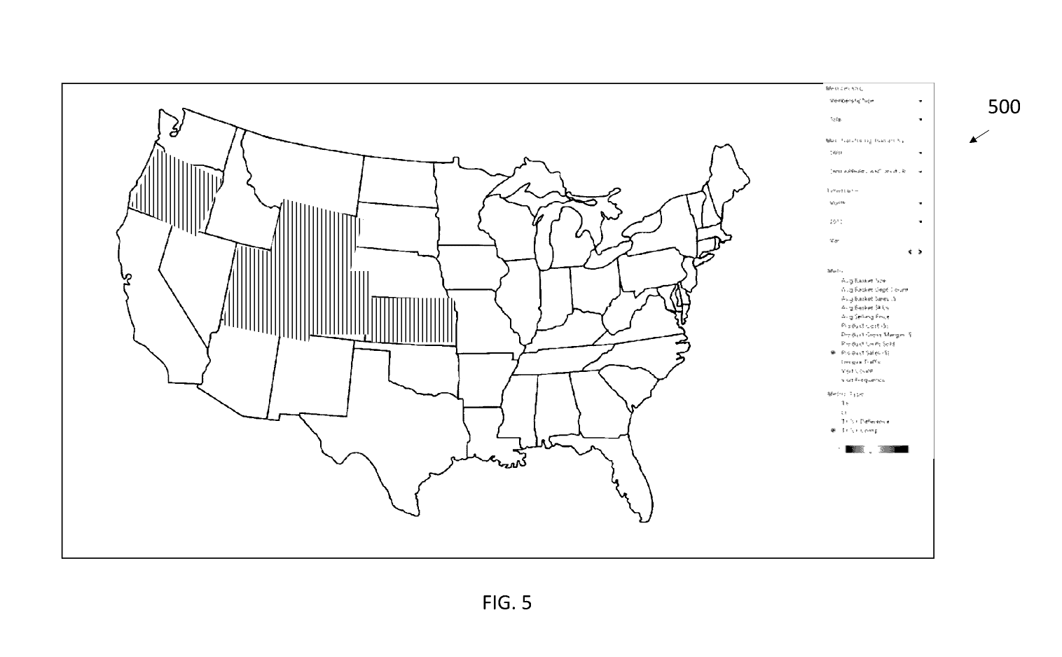

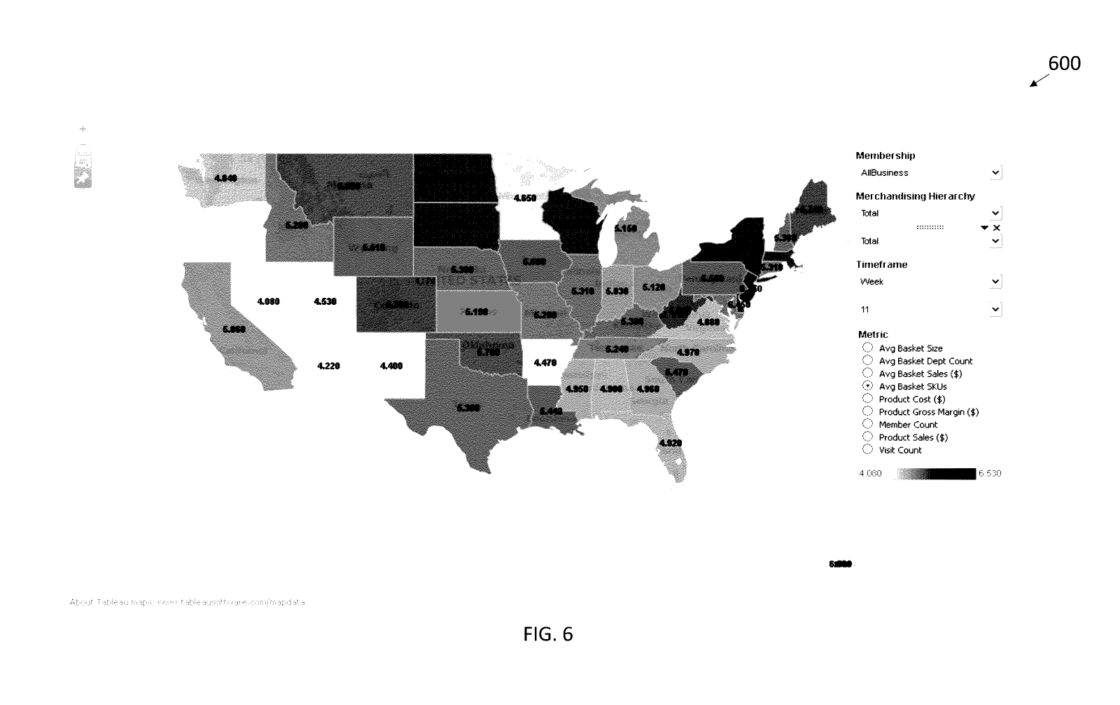

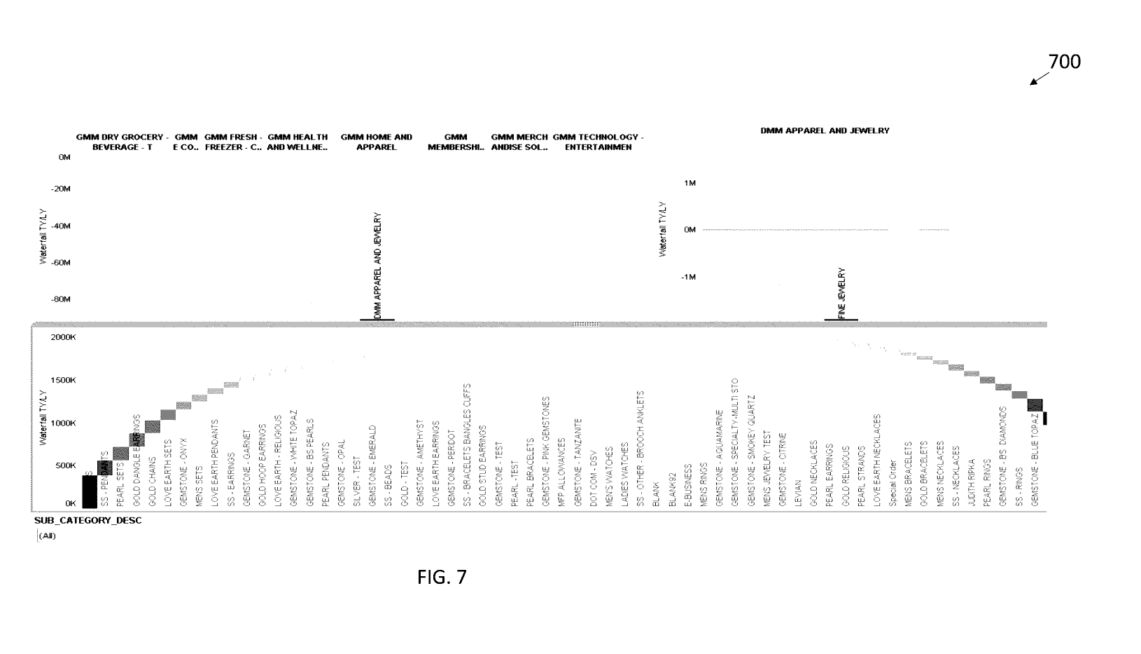

The item analyzer 32 can analyze one or more store items by evaluating sales, profits, or other affinities regarding an item for determining analytic-related information. For example, referring to FIG. 4, the item analyzer 32 may generate evaluation data related to recent sales of rotisserie chicken on the store selling the chicken. In this example, the item analyzer 32 can determine product affinities surrounding the item, for example, sales of mashed potatoes, chopped salads, and so on. The item analyzer 32 can determine whether the sale of rotisserie chicken drives sales and visits to other categories at the retail establishment, such as bakery, deli, produce, dairy, and so on. Changes in these affinities before and after a price change period may be determined, as well as impacts to item sales.

The authentication processor 34 processes authentication data, such as an identifier received from the mobile electronic device 14 to determine whether the user 11 is authorized to receive analytic data, visualizations, and at what level of authority and access.

In some embodiments, the analytics system 20 includes a memory (not shown) for recording actions taken by the user at the mobile device, such as moving to different locations, selecting certain analytics, and so on, which can be used for future analysis and/or performance reporting.

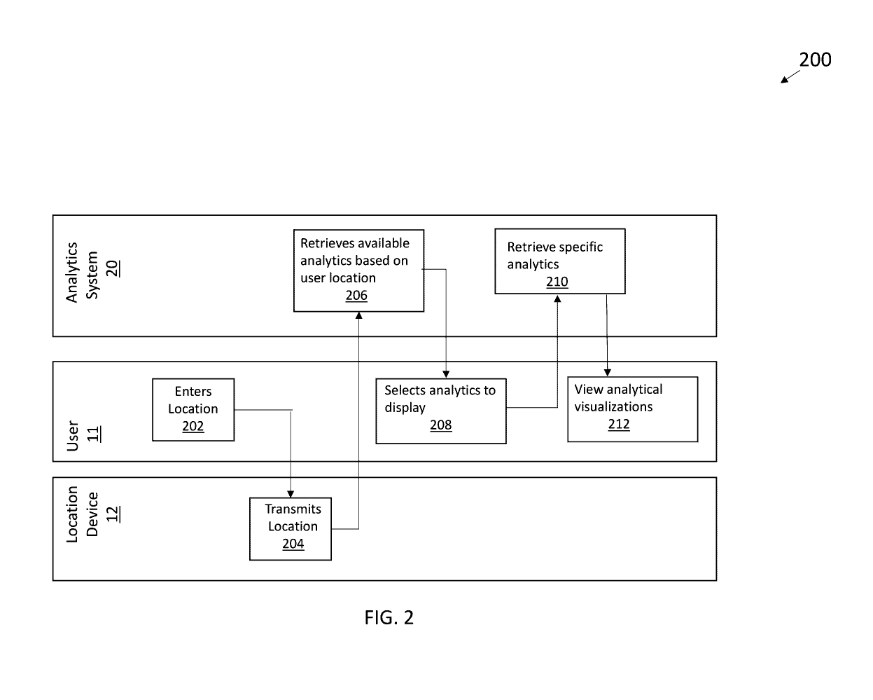

FIG. 2 is a process flow diagram illustrating a method 200 for generating geolocation-sensitive analytics, in accordance with some embodiments. In describing the method 200, reference is made to elements of FIG. 1. The method 200 can be governed by instructions that are stored in a memory of one or more electronic devices, for example, at the analytics system 20 and/or retail store 10 of FIG. 1.

Prior to the method 200, data scientists or the like can create visualizations with location variables. In particular, data scientists can create analytic statistical models which can be applied to any product. The location-sensitive visualizations may be stored at a data repository for subsequent retrieval by the analytics system 20.

For example, a data scientist may create correlation statistical models to evaluate one products performance with other factors. For example, a model can establish whether grape jelly sales are commensurate with peanut butter sales. In another example, a model can establish whether hot chocolate sales increase during snowstorms, or the impact of a football game on beer sales. Many different types of analytics can be developed besides correlation models such as forecast models based upon clustering models.

At block 202, a user 11 enters a store location along with a mobile electronic device 14 such as a smartphone or other electronic device having a display at which one or more analytical visualizations can be presented. At the store location may be products or other items from which information may be obtained, and used for generating analytics.

At block 204, the location device 12 transmits the location of the mobile electronic device 14 of the user to the geolocation processor 22 of the analytics system 20. For example, the mobile electronic device 14 may include a GPS device that determines a location address (street, city, state, country, and so on). As described above, the geolocation technology, for example, LED smart lights, may provide a location number which is mapped to an area within the store 10. The triangulation of the LED numbers enables us to narrow down the location as a smart device can pick up multiple numbers from different LED lights within the store property. Each LED light has a different number. Each number covers a specific area of the store and associates have to map out these numbers and relate them to a digital store map for our use.

In some embodiments, a number associated with a grid location on a 2 dimension or 3 dimension map is output from an LED light or the like, which corresponds to a store location. Information related to items located within a grid section identified by the number is available to the user 11. At the higher level, if no items are within the grid, for example, then the user's detected location can be sent to the analytics system 20, which cross references the number with a table of smart light numbers and determines that there is no item information, but that the user 11 is at a specific store. In this example, the store level may be the location hierarchical level for the summary aggregations, the time would default to this month and the user would be able to see the data (not at the item level but) at the store level. When a user moves into a department area and receives the LED smart light transmission for that department, the smart device would relay that number change to the central computer which would then make the department level the location for the summary aggregations for that department. Smart devices can pick up more than one LED transmission at a time which sometimes enables a triangulation effect giving the system a more specific location on the 2D and 3D grid maps. When a user enters an area of a grid section with items/products, the smart device communicates that number to the central computer which looks up on the LED number/item cross reference and returns to the user what analytics/visualizations are available for those items within an area. When a barcode or product identification is made by the smart device, that information is relayed to the central computer which then narrows the analytics to just that item or product for that store for that month. These factors can be changed by the user. For example, the user may pick a different time than the default.

At block 206, the analytics system 20, in particular, the analytics processor 24, may retrieve available analytics based on the location of the user's mobile electronic device 14. A set of all possible analytics for all items in a region proximal to a predetermined distance from the mobile electronic device 14 can be retrieved, and stored at the analytics system 20, the store database 18, or a remote data repository.

At block 208, the user may select at the mobile electronic device 14 analytics of interest. For example, a list of items may be displayed, which may be selectable by the user 11. In embodiments where a barcode scan is made, a single item, i.e., the item corresponding to the barcode, tag, or other scanned item, is displayed.

At block 210, the analytics system 20 retrieves the selected analytics and provides corresponding visualizations to the mobile electronic device 14 for viewing (block 212).

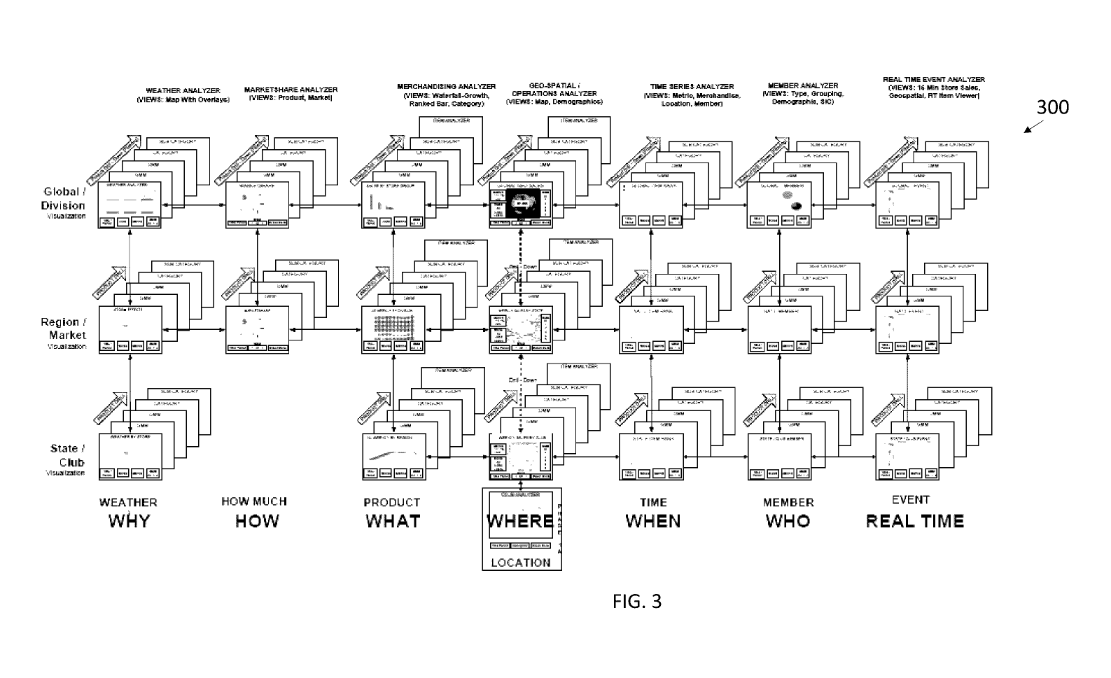

FIG. 3 is a view of an array of visualizations 300, which may be presented in accordance with some embodiments. As described above, the visualizations may be created by data scientists or the like, and may include location variables so that the visualizations include a graphical arrangement or other visual presentation related to store items, which are output to a mobile electronic device 14 when the device 14 is at a predetermined distance from a geographical area that includes one or more items to which the visualizations, e.g., graphs, charts, and so on are associated. The amount, substance, or detail regarding the visualizations displayed may depend on the distance of the user, or mobile electronic device 14, from the location of the items, products, geography, or other elements to which the analytics correspond. For example, when the mobile electronic device 14 is at a first distance from an item of interest to which the analytics correspond, a first amount of analytical visualization data is displayed at the mobile electronic device 14, and wherein when the mobile electronic device 14 is at a second distance from the item of interest that is greater than the first distance, then a second amount of analytical visualization data is displayed at the mobile electronic device 14 that is less than the first amount of analytical visualization data. In some embodiments, the analytics and associated visualizations are constructed and arranged to accept inputs, which may include factors, parameters, or other information formatted as electronic data according one or more of location, product, people, time, and associated perspective.

Geo-spatial item analysis can be performed to illustrate sales, profits, or other information about the item relative to a geographic area, such as city, state, country, division, market, and so on. A hierarchy can be generated, for example, item profits per store, city, state, county, and so on. As shown in FIGS. 3 and 6, a visualization 600 may be provided that relates to sales, profits, or other financial data by state, store, club, or other demographic or location-based metric.

A merchandizing analysis can be performed to determine data on a per-product basis, or other product-related information. A hierarchy can be generated, for example, broken down by department, modular, fine line, or item, so that analytics related to item profits per store, city, state, county, and so on can be obtained. For example, as shown in FIG. 7, a merchandising analyzer of the analytics processor 24 can generate data that is output by the visualization generator 30 as an analytic visualization 700 of store items proximal to the mobile electronic device 14 and their respective sales.

A time series analysis can be performed to provide visualizations related to sales, profits, etc. over a period of time. The time period or “when” may refer to calendar-specific time periods, such as year, quarter, month, week, day, shift, hour, and so on. Sales data can be therefore be collected for a particular time period. For example, as shown in FIG. 8, a time-series analyzer of the analytics processor 24 can generate data that is output by the visualization generator 30 as an analytic visualization 800 of various metrics displayed over time. In some embodiments, combinations of time-related analytics can include maps, demographic displays including weekly sales by club, weekly sales by state, global sales, and so on.

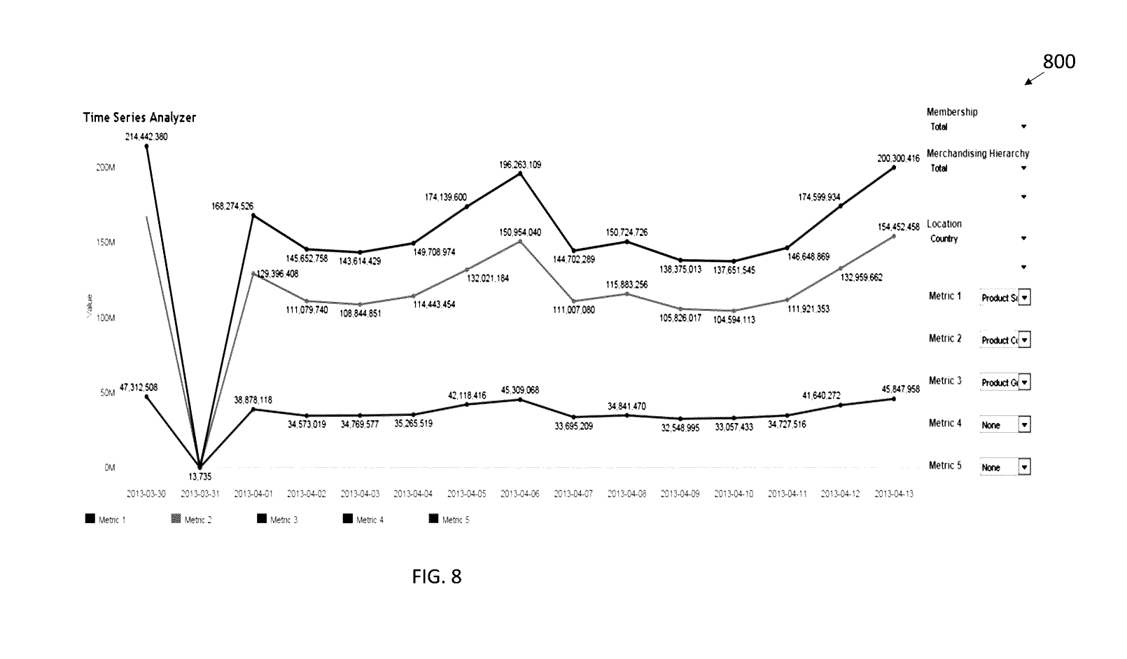

An event analysis can be performed to provide visualizations illustrating the impact of an event. For example, as shown in FIG. 5, an analytic visualization 500 can relate to the impact of weather on store sales. For example, correlation analysis may aid in establishing a cause for a spike or drop in sales is what the user is wanting to understand. For example, determinations can be made whether the weather results in an increase in sales of umbrellas. Related analytics can include the impact of one product sale on another product sale, the impact of an offer, such as a coupon, on product sales, the impact of a demonstration on product sales, the impact of price increases or decreases of a club membership on product sales at the club, and so on. In some embodiments, a real-time event analysis or near real-time event can be performed.

A member analysis can be performed to provide visualizations related to demographics, or other grouping of store customers or members. For example, a membership analyzer of the analytics processor 24 can generate membership metrics that are output by the visualization generator 30 as an analytic visualization in the form of pie graphs illustrating membership types, location, and so on.

FIG. 4 is a process flow diagram illustrating a method 400 for providing geolocation-sensitive analytics, in accordance with some embodiments. In describing the method 400, reference is made to elements of FIGS. 1-3. The method 400 can be governed by instructions that are stored in a memory of one or more electronic devices, for example, at the analytics system 20 and/or retail store 10 of FIG. 1.

At block 402, a user 11 of a mobile electronic device 14 is authorized to use an application that displays analytic visualizations at the mobile electronic device 14. Authorization is determined when the user enters the store 10 with the mobile electronic device 14. The mobile electronic device 14 may be configured with the application, and receive authorization after logging into the application. In other embodiments, a group to which the user 11 is associated may receive authorization. Data, models, visualizations, and so on are associated with the group, so that each user in the group does not need to receive independent assignments.

At block 404, the mobile electronic device 14 transmits an identifier, such as a user identification or the like, to the authentication processor 34 of the analytics system 20.

Also, the mobile electronic device 14 can receive a transmission that identifies the store location, and transmits the identification to the analytics system 20, which uses the store identification to associate the mobile electronic device 14 with the location of the store. In some embodiments, the store 10 transmits the identification via an LED transmission.

At block 406, a search is made for analytics, which is limited to available analytics authorized for receipt by the mobile electronic device 14. Therefore, a determination is first made as to the identity of the user, e.g., name, job title, and so on, along with the authorization of the user, i.e., to which analytics, visualization, and authorization level. For example, a store executive having a home office may have the authority to view data from all stores, while a store manager may only have authority to view analytic data at one store, while a department head may have authority to view analytic data of only a store department. A vendor may only have authority to view analytic data related to the vendor's products. The location of the store 10 at block 404 may be a factor in the query to limit the data being retrieved to the particular store 10.

At block 408, the analytics system 20, the query made in block 406 returns data that can be used to generate a default analytic and visualization based on the user's authority and access permissions. For example, a query result can return data summarized for store sales performance at the point in time based on the current date. The analytics system 20 can summarize this data by compare a current time period, for example, a current month, to a previous month, and provides the comparison result as a default analytic visualization, which can be modified by the user 11, for example, at the mobile electronic device 14 displaying the visualization depending on the available analytics and user preferences. For example, the current time and/or previous time can be modified to a different date range. A default visualization corresponding to the default analytics permits the user to change to what the user prefers to see on the device display by changing hierarchical levels, or changes in other analytic information.

At block 410, the user 11 having the mobile electronic device 14 enters a location, such as a store department, whereby one or more products having associated analytics are identified according to the location, for example, similar to block 202 of FIG. 2 described above. For example, the department may have an identifier that is transmitted via LED transmission or other signal to the mobile electronic device 14, which in turn processes the identifier and forwards it to the analytics system 20, which can query the analytic data retrieved according to the store, time period, and department. Accordingly, at block 412, the analytics system 20 correlates relevant analytics to the mobile electronic device 14 for display and possible selection by the user 11. The system 20 can display a list of analytical information for viewing.

Various analytics can be grouped together, which permits the user 11 to quickly identify analytics of interest. The groupings can be based upon hierarchies, for example, categorized as “who”, “what”, “when,” “where”, and “why” in the array 300 of FIG. 3,

When the user 11 scans an item with the mobile electronic device 14, for example, a bar code scan, item image recognition based on a photograph, and so on, or the user 11 enters an item code or name, the mobile electronic device 14 can output the item bar code, image, name, and so on to the analytics system 20, which queries the data using the received item information to limit the data to the location of the product or item, for example, limited to the store 10 or department, the time period, and the product or item. Analytic results may also be limited to a person, for example, limited to the user 11, or store employees associated with sales of the item or department. This data can also be used for comparison purposes, for example, the compare against a different date range, competitor, other products, and so on.

Applications of geolocation analytics are described, but not limited to, the above. For example, other uses can include event management, for example, monitoring a weather event (e.g., hurricane, tornado, etc.), sales event (e.g., Super Bowl, Black Friday, etc.), national event (Memorial Day, etc.), or catastrophic event (e.g., terrorist attack, stock market crash, etc.), and determine the effect on item, department, or store sales.

As will be appreciated by one skilled in the art, concepts may be embodied as a device, system, method, or computer program product. Accordingly, aspects may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, aspects may take the form of a computer program product embodied in one or more computer readable medium(s) having computer readable program code embodied thereon.

Computer program code for carrying out operations for the concepts may be written in any combination of one or more programming languages, including an object oriented programming language such as Java, Smalltalk, C++ or the like and conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

Concepts are described herein with reference to flowchart illustrations and/or block diagrams of methods, apparatus (systems) and computer program products according to embodiments. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer readable medium that can direct a computer, other programmable data processing apparatus, or other devices to function in a particular manner, such that the instructions stored in the computer readable medium produce an article of manufacture including instructions which implement the function/act specified in the flowchart and/or block diagram block or blocks.

The computer program instructions may also be loaded onto a computer, other programmable data processing apparatus, cloud-based infrastructure architecture, or other devices to cause a series of operational steps to be performed on the computer, other programmable apparatus or other devices to produce a computer implemented process such that the instructions which execute on the computer or other programmable apparatus provide processes for implementing the functions/acts specified in the flowchart and/or block diagram block or blocks.

The flowchart and block diagrams in the Figures illustrate the architecture, functionality, and operation of possible implementations of systems, methods and computer program products according to various embodiments. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

While concepts have been shown and described with reference to specific preferred embodiments, it should be understood by those skilled in the art that various changes in form and detail may be made therein without departing from the spirit and scope as defined by the following claims.

What is claimed is:

1. A method for visualizing data analytics, comprising:
transmitting an identifier by a mobile electronic device of an interested party in or proximal a retail establishment to a computer in communication with a stored set of analytics regarding store items;
determining analytics of the set of analytics within a geographic area proximal a current location of the mobile electronic device;
locating store items within the geographic area to which specific analytics of the determined analytics of the set of analytics correspond; and
presenting at the mobile electronic device one or more analytics of the specific analytics in response to the identifier.

2. The method of claim 1, wherein the mobile electronic device of the interested party is authorized to receive the analytics in response to an acceptance of the transmitted identifier.

3. The method of claim 2, wherein the computer determines from the identifier at least one of an identification of the interested party, a role of the interested party, analytic authorization information, or a level of authorization.

4. The method of claim 3, wherein the mobile electronic device picks up an LED light transmission and communicates back to a location server the location of the user.

5. The method of claim 4, wherein the location server looks up the authority of the user, the available visualizations, statistical models associated with the visualizations, and data that is associated with the models, and wherein the location server applies a location factor to the model along with a default date range for the current data and a default date range for the data.

6. The method of claim 1, further comprising:
determining a location of the mobile electronic device in the retail establishment; and
providing the analytics as analytical visualization data to the mobile electronic device according to the location of the mobile electronic device.

7. The method of claim 6, wherein when the mobile electronic device is at a first distance from an item of interest to which the analytics correspond, a first amount of analytical visualization data is displayed at the mobile electronic device, and wherein when the mobile electronic device is at a second distance from the item of interest that is greater than the first distance, then a second amount of analytical visualization data is displayed at the mobile electronic device that is less than the first amount of analytical visualization data.

8. The method of claim 1, further comprising:
receiving, by the mobile electronic device, an LED light transmission of a value that is mapped to a geographical location on a digital store map;
identifying, by the computer, from the value the geographical location where the interested party having the mobile electronic device is located; and
searching for the available analytics and using the location of the retail establishment as a factor in the query to limit the data retrieved to just analytics for the store.

9. The method of claim 8, where in the number emitted by the LED light transmission identifies a store department.

10. The method of claim 1, wherein the computer provides default analytics and visualization to the mobile electronic device, which can be updated to include different analytics based on a security level of the interested party.

11. The method of claim 1, further comprising:
scanning a store item by the mobile electronic device; and
querying by the computer analytics related to the scanned store item.

12. The method of claim 1, wherein the analytics are generated according to hierarchical levels.

13. The method of claim 1, wherein the hierarchical levels include store, department, modular, and item levels.

14. The method of claim 1, further comprising generating a default analytic and visualization based on the user's authority and access permissions.

15. A method for providing geolocation-sensitive analytics, comprising:
authorizing a mobile electronic device of user to receive analytic data corresponding to at least one item of interest;
receiving, by an analytics system, an identifier from the mobile electronic device;
providing the analytics as analytical visualization data to the mobile electronic device based on the identifier and a result of authorizing the mobile electronic device.

16. The method of claim 15, wherein the analytics are generated according to hierarchical levels.

17. The method of claim 16, wherein the hierarchical levels include store, department, modular, and item levels.

18. The method of claim 15, wherein the amount of analytical visualization data displayed at the mobile electronic device is dependent on the location of the mobile electronic device from the at least one item of interest.

19. The method of claim 15, further comprising generating a default analytic and visualization based on the user's authority and access permissions.

20. An analytics system, comprising:
a geo-location processor that determines a mobile device location relative to items, store areas, departments, vendors, fine-line, and/or categories of interest and have corresponding analytic data;
an analytics processor that retrieves available analytics of the analytic data based on the mobile device location; and
a visualization generator that outputs visualizations related to selected analytics of available analytics.

21. The analytics system of claim 20, further comprising: an item analyzer that analyzes one or more store items proximal to the mobile device location by evaluating sales, profits, or other affinities regarding an item for determining analytic-related information.

22. The analytics system of claim 20, further comprising a threshold generator That compares an item performance level to a threshold value, and generates an alert of analytics regarding the item when the item performance level is greater than the threshold level.

23. The analytics system of claim 20, further comprising an authentication processor that processes authentication data received from the mobile device to determine whether the user is authorized to receive analytic data and visualizations, and at what level of authority and access.
